(19) United States
(12) Patent Application Publication
(10) Pub. No.: US 2018/0045277 A1
(43) Pub. Date: Feb. 15, 2018

(54) GEAR ARRANGEMENT AND METHOD FOR DISTRIBUTING LOAD IN A GEAR TRANSMISSION

(71) Applicant: CASCADE DRIVES AB, Stockholm (SE)

(72) Inventor: Stig LUNDBACK, Vaxholm (SE)

(21) Appl. No.: 15/553,919

(22) PCT Filed: Feb. 26, 2016
(86) PCT No.: PCT/EP2016/054095

§ 371 Date: Sep. 6, 2017

(30) Foreign Application Priority Data
Feb. 27, 2015 (SE) 1550235-4

(51) Int. Cl. F16H 1/22; F16H 19/04

(52) U.S. Cl. CPC F16H 1/22; F16H 19/043

(57) ABSTRACT

A gear arrangement for distributing load in a gear transmission, which gear arrangement comprises an input gear or rack, an output gear or rack and at least two transmission arrangements operationally arranged in parallel for simultaneous divided transmission of the torque and/or motion between the input gear or rack and the output gear or rack. At least one of the transmission arrangements is a load distributing device which comprises a shaft which carries a first gear meshing with the input gear or rack, and a second gear meshing with the output gear or rack. The load distributing device further comprises means for allowing axial movement of at least one of the first and second gears relative to the input gear or rack or to the output gear or rack respectively, and control means arranged to apply an axial force to and/or transfer an axial force from the axially movable first and/or second gear.

### FIELD OF THE INVENTION

The present invention concerns a gear arrangement according to the introductory portion of the independent claim, and more specifically a gear arrangement for distributing load in a gear transmission. The invention provides for division of power so that highly energy dense up and downshifts can be performed using smaller power transmitting gears and bearing loads.

### BACKGROUND OF THE INVENTION

A gear transmission is a device for power transmission which changes the rotation speed, torque and/or direction of rotation from one rotating shaft to another. This can also be done by a rack which transmits linear movement to rotary movement. This power transmission between the shafts and racks is usually made through an interacting meshing of two gears or between a rack and a gear. This means that only two tooth flanks at the time transmit the current torque with rolling and in particular helical gear, also with sliding movement. This mesh with its two mating tooth flanks must be dimensioned for the torque transmitted between them considering both strength and mechanical abrasions. This can be done by making the gears wider and the meshing deeper. The material of the gears and the hardness of the tooth flank material and the lubricating oil of course constitute extremely important factors for increased strength and increased resistance to mechanical abrasions.

Downshift means that the output shaft has a lower speed but higher torque than the input. The opposite occurs in upshift.

Up and downshifts are often performed as gear steps. For geometric-mechanical reasons, each step provides up or downshifts in a ratio of 1:4, alternatively 4:1. Two steps connected in series can thus jointly provide up and downshifts in a ratio of 1:16 or 16:1 and thus result in gearboxes with different power density, torque/weight, which also are linked to the values of the up and downshifts provided by the gearbox.

When high up or downshifts are required, several gear steps may be needed. For gearboxes that transmit input torque and speed to output torque and speed or vice versa, rotation to rotation, the requirement for large power transfers can be solved with larger and wider gears, as well as wider tooth flanks, stronger materials and stronger bearings without changing the up or downshifting ratios. This is not possible for gearboxes intended to transmit linear input or output power to or from a rotating source receiving or supplying power.

For gears and gearboxes which transmit linear movements into rotational movements through a rack, the requirement of increased diameters of the gears results in a reduction of the primary speed generated by the movement of the rack, which means that additional shifting stages must be introduced in the gearbox to maintain desired up- or downshifting, resulting in low power density. That is, this gearbox will be considerably heavier than the corresponding gearbox that converts rotation to rotation.

A natural idea in this context is that instead of making use of a large gear with one meshing, using several small gears which can absorb or transfer power to the rack. Thus, the requirement of a large gear flank area at high powers can be distributed to several gears with small diameters and smaller gear modules so that the transition between the linear movements of the rack is transferred to as high rotational movements as possible for further transmissions in the gearbox.

The problem arises when one again brings together the divided torque to a joint torque on one or more output shafts without forming an over-determination, which in the worst case could mean that only one meshing against the rack or elsewhere in the gearbox has to convey a large part of the total effect. This can lead to increased tooth wear and breakdown.

If one wants to achieve a large power transmission divided on multiple interacting gears, one must ensure that this transmission is evenly distributed on all tooth flanks. This can be partly achieved with very high precision in the manufacture and assembly of the gearbox but becomes more difficult and expensive to perform when larger power transmissions and more gear steps are required. Other local conditions, such as heat development in and around the gearbox, can alter the geometric conditions so that the problems associated with over-determination increase and impair the function and lifespan of the gearbox.

By introducing opportunities for torsion of the shafts that transfer torque to the gears, one can with properly dimensioned shafts usually in the form of larger shaft lengths and thus larger gearboxes, reduce the risk of harmful over-determination.

EP 2921694 A1 (Lundbäck et al) shows a solution where a rack gearbox is equipped with several small pinions connected to respective gears by means of an elastic torsional device which allows a limited elastic relative rotation between the pinion and gear. Such elastic torsional devices reduce the problems arising at over-determined gearboxes. The power density becomes very high as the small pinions through the divided transmission can be equipped with small diameters and low gear modules and supported by smaller bearings. By the torsional device initial variations in gear clearance and other small temporary rotational deviations and changes thereto as well as changed flank pressure become absorbed by the radial torsion and thereby over-determination is prevented. The torsional adjustment is fast because it does not need to accelerate any greater mass. It needs access to relatively large gears or long shafts in order to establish correct torsional conditions. The torsion should be high enough to convey the torque of the drive shaft further in the gearbox and simultaneously not too progressive so that temporary rotational deviations give tendencies to too large over-determined forces on any of the current tooth flanks. The torsion means that a hysteresis is formed between the input and output effects of the gearbox. This results in imprecise positioning values of the rack, in particular when starting and stopping.

US 2011/0247439 A1 discloses a gearbox with a load distributing system which comprises an input shaft connected to two lay shafts which in turn are connected to an output shaft.

The input shaft is provided with a first and a second helical input gear of opposite hand, which are fixed axially to each other and axially movable in tandem. Each lay shaft is provided with an input gear which meshes with a respective one of the first and second helical input gears.

### SUMMARY OF THE INVENTION

An object of the present invention is to provide an enhanced gear arrangement for distributing load in a gear transmission.

Another object is to provide such a gear arrangement which reduces or prevents problems caused by over-determination.

Yet another object is to provide such a gear arrangement which allows for that gear transmissions comprising the gear arrangement may exhibit high power density, i.e. a high power to weight ratio.

Another object is to provide such a gear arrangement which momentarily equalizes the load acting on all gear flanks being in simultaneous contact.

Still a further object is to provide such a gear arrangement which allows for immediate load distribution also when the rotational direction of the gear transmission changes.

A further object is to provide such a gear arrangement which reduces the wear and prolongs the service life of the gear transmission.

These and further objects are achieved by means of a gear arrangement as defined by appended claim 1.

The gear arrangement is arranged for distributing load in a gear transmission. The gear arrangement comprises an input gear or rack, an output gear or rack and at least two transmission arrangements operationally arranged in parallel for simultaneous divided transmission of the torque and/or motion between the input gear or rack and the output gear or rack. At least one of the transmission arrangements is a load distributing device which comprises a shaft which carries a first gear meshing with the input gear or rack, and a second gear meshing with the output gear or rack. The load distributing device further comprises means for allowing axial movement of at least one of the first and second gears relative to the input gear or rack or to the output gear or rack respectively, and control means arranged to apply an axial force to and/or transfer an axial force from the axially movable first and/or second gear.

The invention can be seen as a continuation of the invention disclosed in EP 2921694 A1 (Lundbäck et al). It thus comprises an axial device that passively but also actively can absorb and distribute temporary rotational deviations so that all the involved gear tooth flanks receive the same flank pressure. The active distribution preferably takes place as a hydro-mechanical power distribution which contrary to torsion momentarily distributes initial gear clearance variations and other temporary rotational deviations to all the involved gears and shafts. The hydro-mechanical power distribution means that the resulting torque is almost instantaneously distributed to all involved gears and shafts without force transmitting elastic components except the elasticity modules included in the purely mechanical materials.

The hydro-mechanical power distribution can be likened to the power distribution of the purely mechanical differential gear. That is, it is designed to divide a driving torque on two or more shafts of which each may absorb variations in gear clearance and temporary small rotational deviations in such fashion that the sum of the angular velocities is constant.

If more than one gear is to be used to transmit a joint force, one usually during assembly tries to mechanically adjust, tighten the gear tooth flanks against each other to obtain as even power distribution and possibly also pre-stress as possible so that minor variations of the gear cutting can be taken care of by the elastic moduli of the materials and be carried by the bearings. If the gearbox is used for axial or rotating operation in both directions, the mechanical pre-stress of each gear, must, in principle, also change direction. For larger gears and longer racks, the precision in manufacturing precise gear cutting and temperature changes may produce undesirable over-determinations and wear.

The hydro-mechanical device can not only initially at the time of assembly but also when the gearbox operates under different conditions (e.g. temperatures) independent of rotation auto-regulate so that all tooth flanks in the gearbox receive evenly distributed pressure according to the effect transmission of the gearbox.

With this device it is possible, using several interacting gears, to transfer large axial alternatively rotating forces to large rotating forces with high angular rates or vice versa.

According to preferred embodiments:

The first and second gears may be axially fixed to the shaft and the shaft may be axially movable relative to the input gear or rack and the output gear or rack.

The means for allowing axial displacement of the first and/or second gear may comprise a bearing which allows axial movement of the shaft.

At least one of the first and second gears may be axially movable relative to the shaft.

The means for allowing axial movement of the first or second gear may comprise helical gear flanks arranged on the axially movable first and/or second gear.

The means for allowing axial movement of the first or second gear may comprise an axial spline arrangement arranged at the shaft and/or at the axially movable first and/or second gear.

The means for allowing axial movement of the first or second gear may comprises a helical spline arrangement arranged on the shaft and/or on at least one of the first and second gears.

The control means may comprise an hydraulic arrangement comprising first hydraulic means arranged to urge the axially movable first and/or second gear in a first axial direction and second hydraulic means arranged to urge the axially moveable first and/or second gear in a second axial direction being opposite to said first axial direction.

Tear arrangement comprises a plurality of load distributing devices, wherein the first hydraulic means of all load distributing devices are hydraulically connected for distributing the load of all load distributing devices at operation of the gear arrangement in a first rotational direction, and wherein the second hydraulic means of all load distributing devices are hydraulically connected for distributing the load of all load distributing devices at operation of gear arrangement in a second rotational direction.

The first hydraulic means may be mutually connected by means of a first connection system enclosing a volume of a hydraulic media and the second hydraulic means may be mutually connected by means of a second connection system enclosing a volume of a hydraulic media.

At least one of the first and second connection systems may comprise a connection center for regulating the volume and/or the hydraulic pressure in the respective connection system.

The first and second connection systems may share a common connection center.

The first and second connection systems may be hydraulically separated.

The control means may comprise a resilient member such as a spring or an elastomeric member.

The invention also concerns a method of distributing loads in a gear arrangement, which gear arrangement comprises an input gear or rack and output gear or rack. The method comprises the steps of; dividing and transmitting the torque and/or motion between the input gear or rack and the output gear or rack by means of at least two transmission arrangements operationally arranged in parallel, each transmission arrangement being a load distributing device which comprises a shaft which carries a first gear meshing with the input gear or rack, and a second gear meshing with the output gear or rack, means for allowing axial movement of at least one of the first and second gears relative to the input gear or rack or to the output gear or rack respectively, and control means arranged to apply an axial force to and/or transfer an axial force from the axially movable first and/or second gear, and transferring axial forces and/or movements of the axially movable first and/or second gear of one load distributing device to the first and/or second gear of the other load distributing devices.

The invention thus allows for dividing the total torque that a gearbox conveys into sub-torques so that high up and downshifting steps can be performed with high power density using small gears and lower bearing loads.

The invention may be said to comprise three parts.

One part comprises three basic alternative devices that convert the total torque of the gearbox to partial torques, arranged so that these partial torques preferably to a lesser extent result in axial forces and movements.

The second part comprises devices and combinations of these, which in a dynamic and/or static-passive and/or active fashion can generate forces opposed to the generated axial forces and movements.

The third part comprises devices and ways to, in a controlled manner, balance out any differences that may arise between different gear flank pressures.

The three parts can along with simple sensors, provide ample opportunity for detailed control functions of the gearbox, which in the form of state diagrams, for example, can be conveyed for example via the “cloud” or otherwise for the control and monitoring of the functions and power transmission of the gearbox

One can also obtain, with simple means, double security against the formation of harmful over-determinations.

Further objects and advantages of the invention appear from the following detailed description of exemplifying embodiments and from the appended claims

### SHORT DESCRIPTION OF THE DRAWINGS

In the following exemplifying embodiments of the invention will be described with reference to the figures in which:

FIGS. 1-8 are schematic cross section illustrating the gear arrangement according respective embodiments of the invention.

FIG. 9 is a schematic elevational view illustrating a further embodiment.

FIGS. 10a-b are schematic cross section illustrating a detail in different variations, which may form part of the gear arrangement according to further embodiments.

FIG. 11 is a schematic elevational view corresponding to FIG. 9, illustrating a further embodiment.

### DETAILED DESCRIPTION OF EXEMPLIFYING EMBODIMENTS OF THE INVENTION

The gear arrangement comprises load distributing devices each of which includes a gear unit which basically consists of a shaft, two gears and bearings arranged so that outer external compression forces on the shaft, gears and shaft, or only on the gears, can result in axial movements which through helical gears or splines result in that the two gears when in contact with their adjacent tooth flanks will form helical movements of all or parts of the device until the external forces are counter-balanced. The reverse also applies, that is, the torque developed on the shaft of the device, the gear and the shaft, or only on the gears generates rotational and axial forces so that opposing forces such as hydro-mechanical forces, resilient forces and electromagnetic forces or combinations of these are needed in order to prevent the device from being displaced from its meshing.

The above gear unit can provide the above properties substantially in the form of three principal embodiments which in turn obtain their opposing forces through two fundamental control functions and combinations thereof, all of which prevent over-determination but give the gearbox different properties.

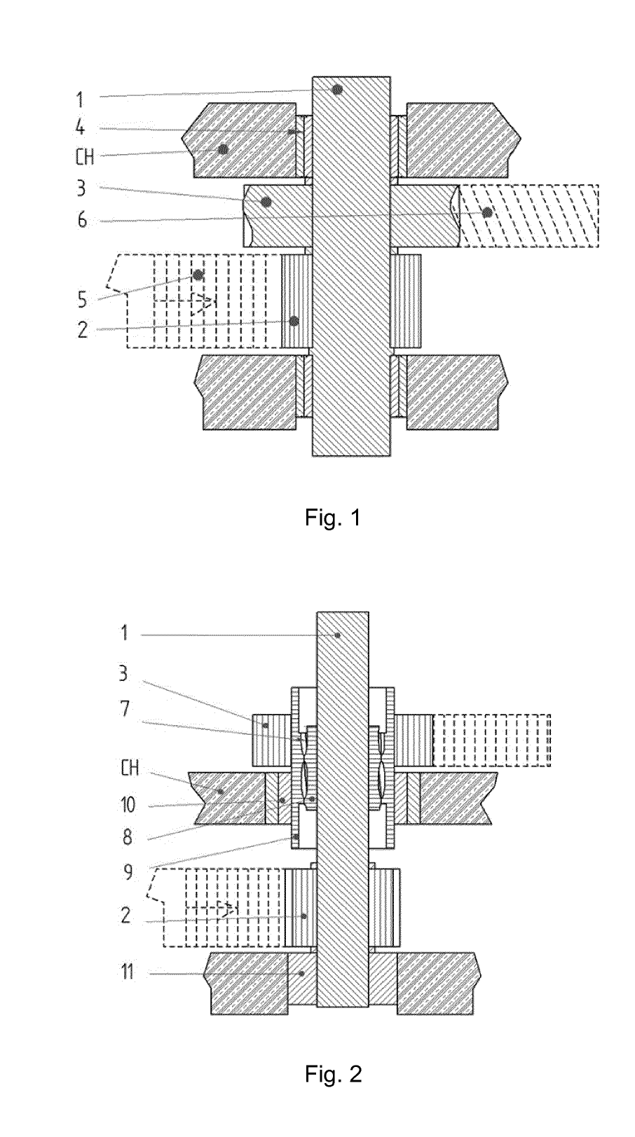

### Basic Embodiment No. 1 FIG. 1

FIG. 1 shows a shaft (1) carrying two gears (2) and (3) respectively, where one of the gears usually has a larger diameter in order for some type of up or downshift to occur. One of the gears in this embodiment, preferably the larger (3) must be provided with helical teeth and thus preferably the smaller (2) with straight-cut teeth. The shaft (1) is supported against the gearbox chassis (CH) with toroidal bearings (4) permitting axial movement within certain limits but providing strong radial bearings. For example, when a gear rack (5) with straight-cut gear teeth moves in the direction of the arrow, one of its tooth flanks will meet a tooth flank of the small straight-cut gear (2) and put the shaft (1) in rotation. The rotation can continue until the gear clearance between the helical teeth of the wheel (3) stops against the corresponding flank on the adjacent gear (6) with the corresponding helical teeth. If this gear offers resistance, this resistance will result in that the gear (3) with its helical tooth surfaces forms axial forces which during rotation strive to displace, in a helical movement, both the large and small gear and their common shaft, i.e. the entire gear assembly, from its meshing. This is entirely possible as the toroidal bearings (4) according to this embodiment allow this. The direction of the axial force and movement is determined by the direction of rotation of the gear (3).

The reverse can also happen. When the gear (6) with its helical edges face the corresponding flanks of the gear (3) the shaft (1) is put in rotation until the shaft (1) via the small gear (2) encounters resistance when these tooth flanks contact the tooth flanks (5) of the gear rack. If the rack offers resistance to movement, the helical flanks of the gear (3) will immediately generate axial forces which during rotation can cause a helical movement displacing both the large and small gear and the common shaft out of their meshing.

The axial force arises because the device has a helical gear and is formed first when this is exposed to torque, which only can occur when the gear unit consisting of the both gears (2), (3) and shaft (1) convey a torque. The strength of the axial force depends on both the torque that the gear unit conveys over the helical tooth flanks of the gear (3) and on the angle of the helical tooth flanks in relation to the tangential forces of the torque.

Axial forces applied against the gear unit for example by pressure on the shaft (1) causes, for this embodiment, the entire gear device to move in a helical-axial movement which means that all tooth flanks towards the gear assembly are forced into contact with each other. The reverse also applies. That is, the gear unit can transmit torque in the gearbox resulting in an axial force produced by the tangential force of the torque against the helical angle of the tooth flanks.

In order for an axial displacement of the entire gear unit to take place, the axial force must overcome all frictional forces arising between the teeth meshing between both gears present on the shaft and the axial sliding movements in the two toroidal bearings. Then, with increasing torque, increasing opposing forces are required, so that the whole gear unit does not move beyond the variations permitted by the clearance of the gears. During operation, the friction forces are expected to be low as virtually all sliding functions take place as a combination of rolling functions surrounded by an oil film. After standing still and strong start and stop of the gearbox functions, the axial sliding movements cause greater friction forces why there may be reasons to create enough high axial forces so that no tendencies to over-determination should occur. Further, there is a need for adapted opposing axial force devices that can counteract and equalize arisen axial forces and movements, so that all tooth surfaces receive the axial force needed to transmit torque in the gearbox. This is further described under the headings for the basic control functions and figure and caption.

### Embodiment No. 2 FIG. 2

FIG. 2 shows a shaft (1) carrying two gears (2) and (3) where usually one of the gears has a larger diameter in order for some form of up or downshifting to occur. One of the gears preferably the larger (3) shall be equipped with straight teeth. The second gear, the smaller, may be provided with either helical or straight teeth as in this example. Instead of as shown in embodiment no. 1 where helical axial forces and movements are generated by the helical tooth flanks of the large gear (3), this embodiment no. 2 has transferred these features to a ball bearing supported helical spline device (7) on the shaft (1).

The inner part (8) of the ball bearing supported spline device is fixedly mounted to the shaft (1) while its outer part (9), in this example, forms a tubular shaft for fixing both the toroidal bearing (10) and the gear (3). The shaft (1) is axially fixed with suitable bearings (11) against the gearbox chassis (CH).

Through the fixing of the shaft to the gearbox with ball bearings (11), the gear (3) that is locked to the ball bearing supported helical spline device outer ring (9), together with the inner ring (10) of the toroidal bearing become subject to axial forces and movements unless the axial forces are counter-balanced. When in time the axial forces occur and how big they become for this gear unit is principally determined by when in time the gear flanks come in contact with each other by torque or linear forces (rack) over the helical spline assembly (7). Through the ball bearing supported helical spline device the axially formed frictional forces can be reduced to primarily encompass the axially sliding movements that arise between the straight cut tooth flanks of the gear (3) and the opposite tooth flanks and the sliding movements that arise in the toroidal bearing (10).

The solution with the spline device (7) also decreases the mass to be axially moved. Because of this, the helical angles of the ball bearing supported spline device are reduced, i.e. become more vertical, which means that the axial forces and movements to be balanced can become lower. This means however also, as for the helical tooth flanks, that the axial clearance may increase before the flanks come in contact with each other.

The above embodiment can also be performed with helical splines without rolling balls, but is then expected to provide significant frictional resistance to helical axial movements that can increase the risk of harmful over-determination.

Balancing the axial forces and movements is described under the headings for the basic control functions and figure and caption.

### Embodiment No. 3

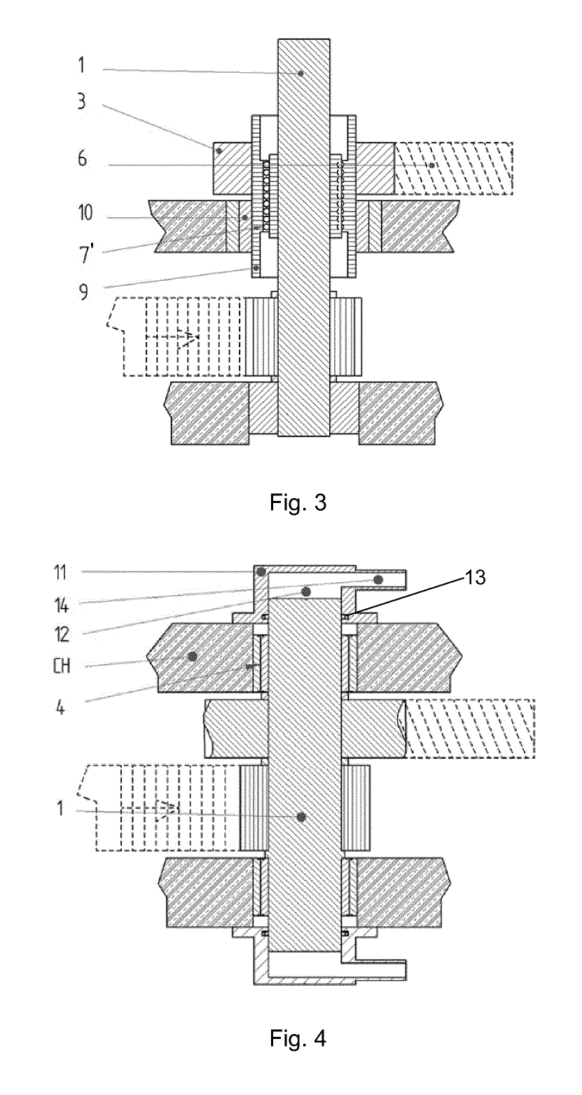

FIG. 3 is similar in principle to the present embodiment no. 2.

Unlike the arrangement in FIG. 2, the ball bearing supported spline device (7) consists of straight splines, which means that it can only convey torque to and from the shaft (1). In order to provide axial forces the gear (3) is provided with helical tooth flanks. Apart from that, the mechanical arrangements remain the same.

The large gear (3) must therefore be provided with helical tooth flanks. Furthermore, the gear (3) must be connected to the shaft (1), in this embodiment no. 3, through straight axial cut ball bearing supported splines. Similarly to embodiment no. 1 torques transferred from the shaft (1) of the present device over the straight axial cut ball bearing supported spline device (7′) will cause the gear (3) to generate axial forces when it comes in mesh with the gear (6). As the toroidal bearing (10) allows certain axial movements, and as the ball bearing supported axial spline device (7′) provides little resistance to axial movement, axial forces that move the gear (3), the tube formation (9) and the inner ring (10) of the toroidal bearing in the axial direction will form, unless no suitable counter-force handles this axial force and movement.

Axially formed friction forces can, through the ball bearing supported straight spline device (7), be reduced to primarily cover the axial sliding movements against the helical tooth flanks of the gear (3) and the sliding movements of the toroidal bearing (10). Furthermore, in common with embodiment no. 2, the mass which is subjected to axial movement is reduced. Because of this, the helical angles of the gear (3) can be reduced, i.e. become more vertical, which means that the axial forces to be balanced can be lower. Balancing the axial forces and movements is described under the headings for the basic control functions and figure and caption.

Basic Control Functions

The embodiments 1-3 have shown how one, by gear devices can arrange two gear wheels, a shaft and its bearings in such a manner as to produce axial forces when the gear device through the common shaft (1) transmits torque between the two gears (2) and (3). The gear devices are further arranged so, that it always has a gear with helical tooth flanks or spline devices with helical splines. These helical tooth surfaces or splines will under applied torque form axial forces, the strength of which, disregarding friction, partly depend on the torque transmitted over the helical tooth flanks or splines and partly on the angle these have in relation to the tangential forces of the torque. Without contact between the helical tooth flanks or splines no axial forces and movements are formed. This means, when more than one gear device is involved in an interacting transmission, which is the basic idea of the entire invention, that in principle only one of the gear devices, by over-determination, gets to carry the load and transmit high torques and generate high axial forces. The rest of the gear devices can with their tooth flank clearance in principle only follow the rotational movements without transmitting the torque and therefore do not produce any axial forces.

The gear devices are therefore provided with possibilities of using internal and/or external controlling forces force the entire or parts of the gear device to an axial movement. This axial force and movement leads through the helical tooth flanks or splines to helical movements that force the tooth surfaces of the gear device in contact with their opposing tooth surfaces. Thereby the axial force (f) is formed as a function of the tangential force (F) of the torque against the helical angle (a) of the tooth flanks according to the formula (f=F×tangent(a))

In order for the gear devices to fulfill their functions of absorbing and distributing torque in the interacting power transmissions, they must be equipped with features, devices in the form of control means capable of absorbing and/or applying axial forces from and to the gear devices. If the rotation of the gear devices changes, these devices also have to change their acting force directions so that there will always be a force direction that, via axial movement, forces the tooth surfaces of the gear device in contact with their opposite tooth flanks so that a torque that corresponds to the forced axial force (f) can be passed on in a collaborative power distribution.

The collaborative power distribution can be done with two basic control functions and combinations of these.

Control Function No. 1

The basic devices 1-3 provide axial forces and movements that are in direct mechanical contact with the tooth flanks. They can thus form the basis for piston functions which together with corresponding cylinder functions can give a double-acting one axial hydro-mechanical device or hydraulic means capable of converting the torque, gear clearance variations and other temporary rotational deviations into pressures and flows that provide basis for the basic hydro-mechanical control functions.

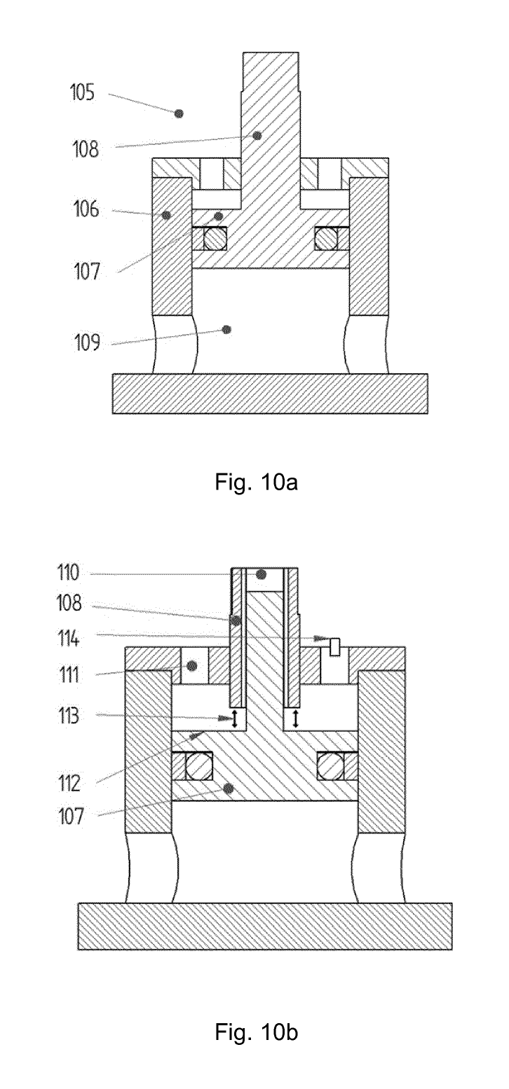

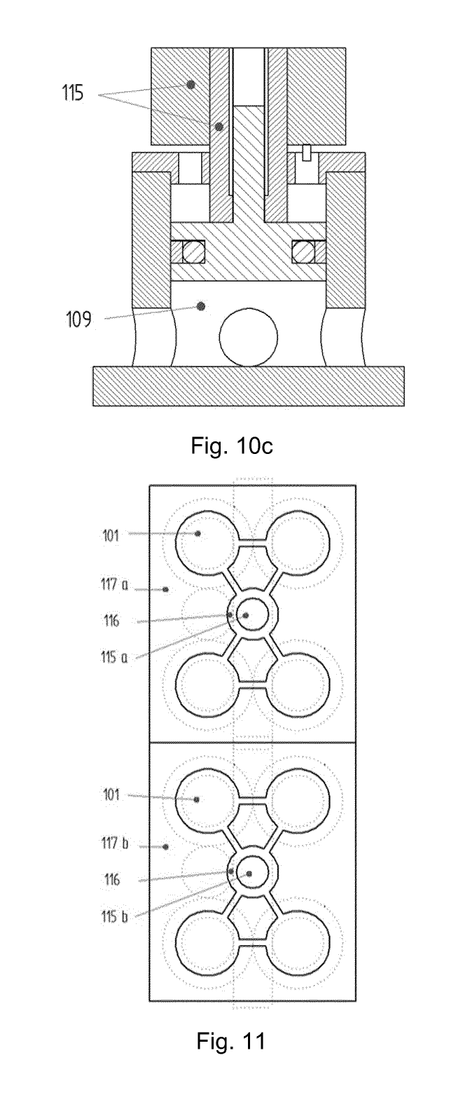

The hydraulic means or hydro-mechanical devices are double-acting. They generate an overpressure on the side where the piston function displaces a volume simultaneously as they on the opposite side basically form a vacuum which automatically and/or in a controlled fashion can be replaced with a volume supplementation via a connecting center see FIG. 10

The hydro-mechanical devices in turn may directly and/or over a passive and/or active connecting center, including hydraulically, communicate with similar hydro-mechanical units active in phase forming well-balanced and even verifiable gear tooth flank pressures on all or in group collaborating gear units in the gearbox. This may, for alternating directions of the input and output forces in the gearbox, occur as two or more parallel control systems that can share common control and regulation functions with each other. Once all the tooth flanks are in contact with each other, which as mentioned above can be either by applying axial or rotational forces to the gearbox, or by applying outer external compressive forces to the shaft, gear and the shaft, or only on the gears, only extremely small volumes will be moved between the hydro-mechanical units. These will primarily transmit the axial flank pressure resulting from the total torque transmitted by the gearbox divided by the number of collaborating hydro-mechanical devices. The coupling system (FIG. 10c) can be equipped with a device that initially when the power transmission of the gearbox approaches zero in order to stop and/or change direction, can provide the coupled hydro-mechanical units with an initial partial volume which means that the gearbox change of active tooth flanks can be done very quickly, see also the text to FIG. 10c. In the text to FIG. (11) it is described how the accuracy of the gearbox can be improved if it for example is used to drive a coordinate controlled device.

In the above way, the effects that the gearbox converts to different torque and angular velocities, are very evenly distributed.

A suitable term for this control function may be that it consists of an axial hydro-mechanical differential gear.

Examples of hydro-mechanical gear units are described under the headline figure and caption.

Control Function No. 2

The basic devices 1-3 also provide axial forces and the movements that can form the basis for mechanical devices which, using progressive forces, for example by compression of springs and/or elastomers, can reduce the risk of harmful over-determination arising. The progressive forces of the springs and/or elastomers may be subject to change by electromechanical and/or hydraulic impact, see FIG. 8.

Unlike radial torsion described in the patent (xxx Lundbäck et al) the springs and/or elastomers only need to autoregulate against and with the axial forces and movements generated by the basic devices 1-3. This means that the elastomers and the springs can be made considerably smaller as exemplified by figures images 5, 7, 8.

Combination of the control functions no. 1 and no. 2 provides double security with maintained properties provided by the axial hydro-mechanical differential gear.

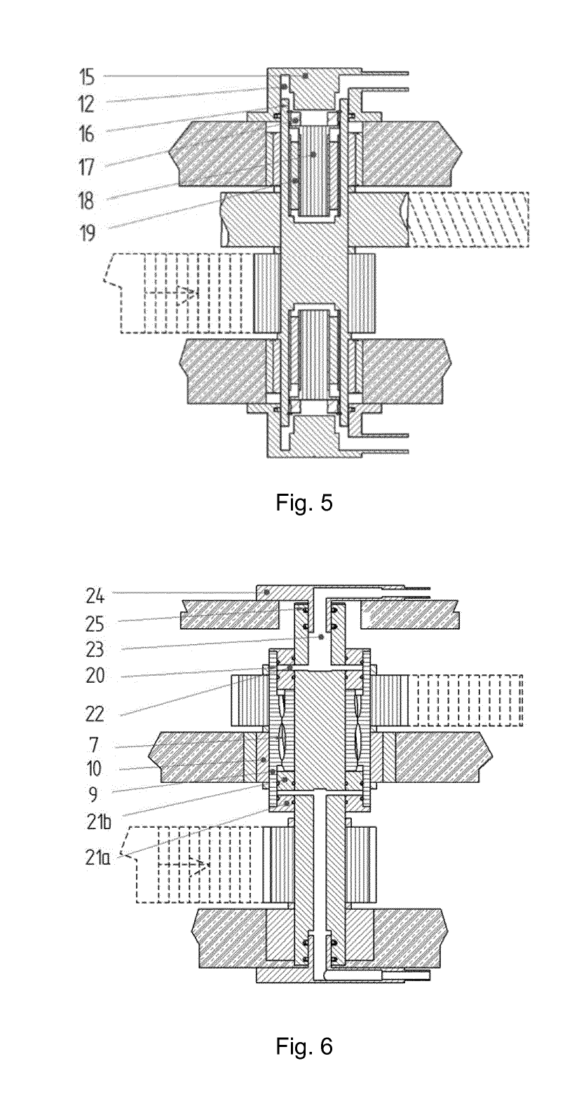

Combination embodiments of the control functions 1.2 are disclosed under FIGS. 5, 7 and 8.

The combination of control functions no. 1 and no. 2 provides with simple means double security to prevent harmful over-determination from arising simultaneously as the properties of the axial hydro-mechanical differential gears primarily can be used in the gearbox.

FIG. 4

FIG. 4 has already been the subject of description of the basic device 1 for providing axial forces and movements that in addition to possible friction and acceleration forces reflect the current transmission work that prevails between the tooth flanks.

The axial forces and movements generated may form the basis for piston functions which together with the corresponding cylinder functions form pump functions that can convert torque, gar tooth clearance variations and other temporary rotational deviations to pressures and flows that provide a basis for basic hydro-mechanical control functions.

By extending the shaft (1) after its fixing to the inner rings (4) of the toroidal bearings, the shaft has opportunities to form the piston functions on each side of the mountings of the toroidal bearings to the transmission chassis (CH). A cup-like housing (11) forming a cylinder (12) has been provided with seals (13) that can handle both axial and rotary movements when they during rotation as well as small axial movements seal against cylinder (12) which is filled with oil. The cylinder has an inlet (14) which also can be an outlet. Thereby the basic device no. 1 together with the two facing pump features forms a hydro-mechanical unit (U) in accordance with the basic control function no. 1 which means that it using its two pump functions can communicate with similar phase active hydro-mechanical units to form well-balanced and even verifiable tooth flank pressures of all collaborating gear units in the gearbox.

FIG. 5

The device in FIG. 5 is also provided with a basic control function according to no. 2 in order to in this case serve as an emergency solution in case the basic control function according to no. 1 should fail.

The cylinder head (15) and the end (16) of the rotating shaft, which also constitutes the piston function, are designed so that they can provide an added security preventing over-determination from occurring if the hydraulic back pressure in the cylinder (12) for any reason ceases. The cylinder head is designed to provide a hydraulic damping against the piston, i.e. the shaft, suddenly in lack of oil pressure would shoot off into the cylinder head (15). The piston i.e. the shaft is also in its central cylindrical recess (16) provided with a roller thrust bearing (17). This roller bearing comes into operation if the oil pressure in the cylinder (13) does not match the axial forces generated by the basic device no. 1. The shaft—the piston will then move towards the cylinder head (15) which following the hydraulic damping against the cylindrical recess (16) of the shaft hits the roller thrust bearing (17) which via a plunger (18) displaces a resilient elastomeric member (19) for a progressive absorption of the axial forces and movements generated by the current power transmission in the gearbox but also the forces and movement variations caused by gear teeth clearance variations and other temporary rotational deviations. In this manner it is avoided that a harmful over-determination destroys the gearbox until overhaul and repair can be performed.

FIG. 6

FIG. 6 have already been the subject of description of the basic devices 2 and 3. In both cases the basic device result in that only the outer part (9) of the helical or straight spline device (7) with attached gear (3) and toroidal bearing inner ring (10) is allowed to transmit the axial forces and movements generated by the device. These reflect in addition to possible friction losses and acceleration forces, indirectly via the helical spline device (7) in basic device (no. 2) or directly via the helical tooth flanks of the gear (3) in basic device (no. 3), the forces and which tooth clearance that exists between tooth flanks.

As with the device in FIG. 4, the generated axial forces and movements can form basis for piston functions which together with the corresponding cylinder functions form pump functions that can convert torque, gear tooth clearance variations and other temporary rotational deviations to pressures and flows that provide a basis for basic hydro-mechanical control functions.

In the basic embodiments 2, 3, the axial pump function can be established according to the following example:

The outer part (9) of ball bearing supported spline device (7) which in this embodiment consists of helical ball bearing supported splines, has in this example been manufactured so that this part also towards its ends merges to form inner cylinders (20) which with two opposing ring-shaped pistons (21a) and (21b) form a cavity (22) between them that is filled with oil, and which through channels (23) provided in the shaft and a swivel device (24) can convey pressure and flow in order to provide a uniform power distribution of the effects that the gearbox is converting to different torque and angular velocities in accordance with the control function nr1.

The pistons (21a) are securely anchored in the outer part (9) and thus form opposed pistons to the pistons (21b) resting against the inner ring (8) of the spline device. During axial movement of the outer part (9) and thus also axial movement of the gear (3) and the inner ring of the toroidal bearing (10) a pump function is formed in accordance with the control function no. 1.

The oil swivels (24) are simple devices which are inserted in the shaft (1) with two axial and radial bearings (25) arranged in the shaft or in the swivels to provide proper control. A loose anchoring against the gearbox is provided to avoid forced control.

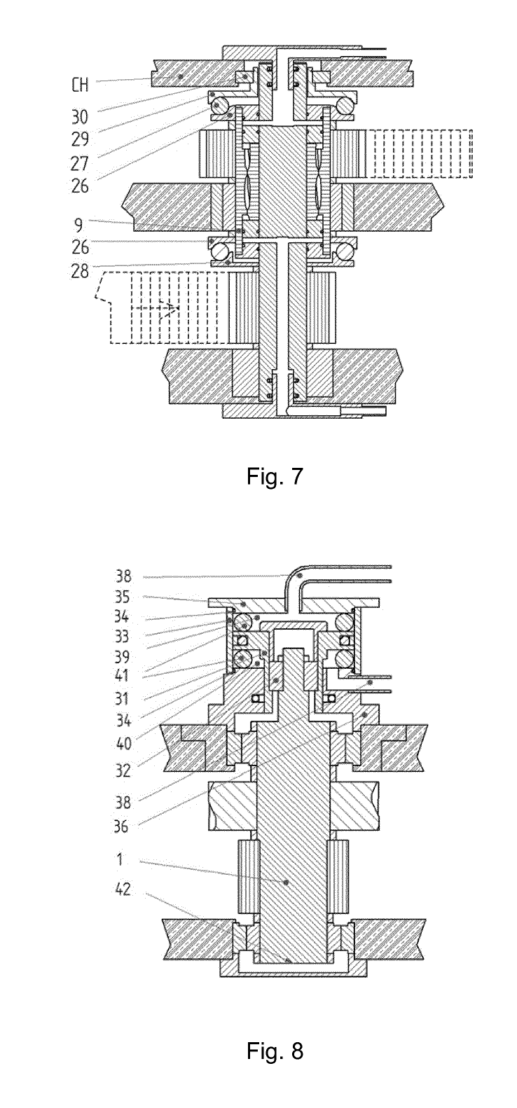

FIG. 7

FIG. 7 shows an example where the control function no. 2 with small changes can increase security to prevent breakdowns of transmission in case the axial hydro-mechanical differential gear fails

The tubular outer part (9) of the ball bearing supported spline device (7) has been provided with two form-fitting rings (26) to an elastomer (27) bordering to two additional form-fitting rings (28) and (29). Ring (28) rests via a spacer on the gar (2) and is thus supported. Ring (29) also need an anvil and gets this indirectly via the ball bearing (30) against the chassis (CH).

FIG. 8

FIG. 8 shows an example of a solution in which the axial forces and movements generated by the hydro-mechanical units can be recovered and countered on one and the same side. It is also equipped with both control function no. 1 and no. 2 for double security to prevent harmful over-determination arising if the precise control function no. 1 should fail.

The basic construction is basically the same as for FIGS. 1 and 4. The principal difference lies in that the shaft (1) presses and pulls respectively in a double-acting piston (31) over a ball bearing assembly (32). This means that the piston does not need to rotate to absorb and impart axial forces and movements which makes it more suitable for auto-regulating against springs and elastomers according to the control function no. 2.

The piston is surrounded by a cylinder (33) connected via O-rings (34) to a cylinder head (35) and a cylinder base (36) having inlet and outlet connection (37) and (38) respectively. The piston separates two chambers (39) and (40) which in this case except oil also enclose a respective O-ring (41).

When the gear assembly of embodiment no. 1 generates its axial forces and movements, which in this embodiment comprise the entire gear unit, the piston in case of changing directions of movement will either develop pulling or pushing movements communicated to the piston (31) via ball bearing means (32) to form axially sliding movement along the cylinder (33) and cylinder base (36). Thus, power is transmitted to both the oil contained and to the trapped O-ring (34) which however is not expected to absorb that much force as long as the control function no. 1 functions (see “basic settings” below). The resulting oil pressure in the active chamber is directly or indirectly via a connecting center in communication with other hydro-mechanical units so that a uniform pressure distribution occurs across all the affected tooth surfaces.

If the oil pressure is lost, the axial movements will become significantly higher as the elastomers develop progressive opposing forces.

The piston (31) is provided with stop features (42) to prevent O-rings (41) from being broken by pressure by the air passing beyond the O-rings (34) when the system is vented under a strong pressure.

It is also possible to separate the two control functions from each other by providing the lower end of the shaft (42) with a ball bearing supported piston feature the only task of which is to compress the O-rings (41) in the presence of oil pressure and demands on communicating pipes. The upper hydro-mechanical unit will, as long as it works, distribute all the torque in a coordinated fashion evenly across all tooth surfaces in both directions.

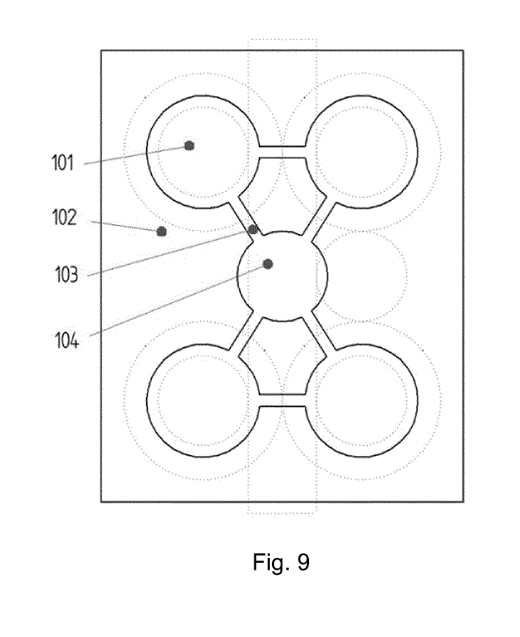

FIGS. 9 and 10

FIGS. 9 and 10 illustrate step by step how passive and active control device and functions can be arranged so that the hydro-mechanical devices of the invention can receive optimal and desirable characteristics that can satisfy different purposes.

FIG. 9

FIG. 9 schematically shows a top view of how 4 hydro-mechanical units receiving and transmitting power in a rack gearbox can be deployed and hydraulically connected to each other. FIGS. 4-7 show by 4 variants of hydro-mechanical units how the reciprocating movements of the gear may be divided into sub-operations that together with the axial forces and movements of the hydrodynamic units can provide equally spaced tooth flank pressure.

The 4 hydrodynamic units (101) in this example can according to the invention be connected to a connecting system (102) with fully rigid pipes (103) or with connecting centers (104) such that a constant enclosed oil volume is formed. If no oil leaks exist, two similar coupling systems on opposite sides in the form of completely closed systems be capable of giving the gearbox a uniform load in both directions of the hydrodynamic units. FIG. 8 shows that it is also possible to place two similar systems on the same side of the gearbox.

Changed rotation means that the gear tooth flank pressures shift side which in turn means that the described piston functions with their axial forces and movements also change direction. Therefore, there will be a volume constriction and over pressure in the direction in which the tooth flanks are active, i.e. pushing the piston towards the trapped oil volume in the upper or lower connecting system (102). At the same time, an expansion of the opposed coupling system occurs, resulting in an under pressure in this coupling system, i.e. its tooth flanks are inactive. This may in certain contexts and conditions be acceptable and lead to the hydro-mechanical units resuming their starting positions when not under load.

FIG. 10a

FIG. 10a shows examples of how, by a modification of the center (104) to a diaphragm device (not shown), or a piston assembly (105), among other things can calibrate the hydro-mechanical units around a center line when not under load. The piston assembly (105) consists of the cylinder (106), the piston (107) and the actuator assembly (108). By in this embodiment, adjusting the adjustment device (108) the enclosed oil volume (109) can be influenced so that the hydro-mechanical units (101) (not shown) with axial movements, and thereby also with a certain rotation, may move their tooth meshing so that they end up in the middle of their opposing gear when not under load. To achieve this center line, one must in parallel also adjust the actuator assembly (108) for the opposing closed system. This results in that the axial movement of the hydro-mechanical device during load occurs with as similar displacements around the center line as possible.

With this simple arrangement one cannot compensate for negative pressure.

FIG. 10b

FIG. 10b has the same structure as FIG. 10a but with the difference that the piston (107) is not firmly attached to the actuator assembly (108), which means that the piston can neutralize lack of oil and resulting vacuum with a pendulum volume (113). For calibration, the procedure is the same as described under FIG. 10a.

When the gearbox is put under load a pressure side and a suction side will form, as previously described. Thus, one of the closed coupling systems (102), with the now described modification, will handle pressure that is evenly distributed on the active tooth flanks, while the other closed system can handle the negative pressure.

For the pressure side, this does not involve any changes as the piston (107) obtains a counter force by resting against the adjustment device (108). On the negative pressure side the piston can move along the pressure gradient formed by the atmospheric pressure against the oil pressure. This can be done by the piston (107) being provided with a support shaft (109) which runs freely in a hole (110) with bearings in the actuator assembly (108). Through the holes (111) the atmospheric pressure can reach the top of the piston (112) and form a pressure gradient guiding the piston away from the actuator assembly (108). In this way, a pendulum volume (113) is formed, which is equal to the piston area times the stroke length. This stroke length can be measured with an appropriate sensor (114).

When the gearbox changes direction, reverse pressure gradients will form pushing the piston (107) back against the default formed by the actuator assembly (108). The pendulum volume (113) formed can form basis for oil refills and how large the general tooth clearance the gearbox has, and as a measure of the degree of wear of the teeth.

FIG. 10c

FIG. 10c shows an electro-mechanical version of the device described in FIG. 10b and which may be used to pre-stress, fine tune and maintain fixed positions. The actuator assembly (108) has been replaced with a symbolically drawn step motor which for example drives a roller screw device (115) that can actively displace the enclosed oil volume (109) and which thereby is able to actively axially displace all the interconnected gears of the hydro-mechanical unit up or down. This active process can speed up the change of active tooth flanks when changing direction of rotation. It can further, in the form of small hydraulic auxiliary engines, through the twisting movements that the hydro-mechanical units provide, fine tune the stop positions of the gearbox in a more precise way.

It is further possible to automatically fill the two coupling systems (102) with oil, using sensors and electric valves, while it simultaneously is possible to check and adjust the hydro-mechanical units working around an optimal center line.

FIG. 11

FIG. 11 shows a schematic illustration how one, using modified power connection sockets (116) according to FIG. 10c may pre-stress a gearbox having hydro-mechanical units according to the invention

It can be seen from the previous text that the hydro-mechanical units can hydraulically distribute an evenly balanced force to all tooth flanks that actively absorb or provide partial torque to the total torque handled by the gearbox.

For example, by dividing the gearbox in two hydro-mechanical groups (117a) and (117b) which may interact with each other over a mechanical gear, two hydrodynamic coupling systems exist which purely mechanical can interact with each other over an output or input shaft (not shown). If the two hydro-mechanical groups are provided with the motor-driven junction boxes according to FIG. 10c, it opens opportunities to create pre-stressed properties in the gearbox using applied hydraulic forces of the stepping motors (115a, b) a total of 4 pieces.

In the example, the groups (117a) and (117b) have 4 hydro mechanical units (101) each, which in cooperation drive a common output shaft (not shown.

If for example group (117a) having active tooth flanks is subjected to a small volume displacement, via the active step motor (115a), then this will cause, as previously described, the gars of the hydraulically interconnected hydro-mechanical units to be shifted towards the inactive tooth flanks, i.e. shifted from its optimal center line toward the inactive tooth flanks. This leads to a slight twisting movement that could pre-stress gears and shafts unless the gears of the common shaft (not shown) transmitted this light rotational change to the group (117b) to the same extent. Its hydrodynamic units will attempt to adjust their axial forces by axial movements to this rotation change so that balance is achieved again. If this balance is prevented by an active opposing force of the stepping motor (115b), this sequence of events, together with the linking gears between the two groups, will give the gearbox a pre-stress which improves its positions. In addition, the step motors (115a, b) can fine-tune the stop positions of the gearbox via the hydro-mechanical units. When changing the operating direction of the gearbox, the step motors (115ab) take part in this and pre-stress the gearbox in the other direction

The coupling systems (102) are also provided with bypass lines and mechanical shut-off valves as well as connections for performing the last difficult bleeding of the systems. By applying a positive pressure that is above the maximum operating pressure of the device, the sealing O-rings of the device will allow air to pass regardless of the positions of the gearbox see FIG. 8. Venting is facilitated as the bleeding device can switch the flow direction and thereby force the hydro-mechanical devices to axial movements, which hence gives the gearbox alternating torque directions.

In cases where elastomers are involved as additional security, as is the case in FIG. 8), the device is provided with a stop function (31) that prevents the elastomers from being damaged.

In addition to what is shown in the drawings it is further possible to provide the gear arrangement with various sensors such as pressure sensors, capacitive sensors and thermal sensors. These may be positioned to register how tooth clearance, wear, change over time concerning the hydro-mechanical units and further to see if special heat developments and vibrations occur, that require check-up and service. The hydro-mechanical coupling systems can compensate for wear until the instructions require new components.

If one knows the cut angle of the tooth flanks or the helical splines and what the friction is, one can determine the effect developed by the gearbox by recording pressures and speeds. One can further, through the oil pressure which i.a. depends on the torques developed in the gearbox also receive signals that reflect how hard the gearbox is loaded, and possibly give warning signs of overload, wear, etc.

In this way, the gearbox can be provided with state diagram, which using transmitter and receiver can transmit and receive signals for example via the “cloud” or otherwise, to and from operator or supervisors of the gearbox.

The present invention is not limited to the above described preferred embodiments. Different alternatives, modifications and equivalents can be used. The above embodiments shall thus not be seen as limiting the scope of the invention which is defined by the attached claims.

What is claimed is:

1. A gear arrangement for distributing load in a gear transmission, which gear arrangement comprises an input gear or rack, an output gear or rack and at least two transmission arrangements operationally arranged in parallel for simultaneous divided transmission of the torque and/or motion between the input gear or rack and the output gear or rack, wherein at least one of the transmission arrangements is a load distributing device which comprises
a shaft which carries a first gear meshing with the input gear or rack, and a second gear meshing with the output gear or rack,
means for allowing axial movement of at least one of the first and second gears relative to the input gear or rack or to the output gear or rack respectively, and
control means arranged to apply an axial force to and/or transfer an axial force from the axially movable first and/or second gear.

2. A gear arrangement according to claim 1, wherein the first and second gears are axially fixed to the shaft and the shaft is axially movable relative to the input gear or rack and the output gear or rack.

3. A gear arrangement according to claim 2, wherein the means for allowing axial displacement of the first and/or second gear comprises a bearing which allows axial movement of the shaft.

4. A gear arrangement according to claim 1, wherein at least one of the first and second gears is axially movable relative to the shaft.

5. A gear arrangement according to claim 1, wherein the means for allowing axial movement of the first or second gear comprises helical gear flanks arranged on the axially movable first and/or second gear.

6. A gear arrangement according to claim 5, wherein the means for allowing axial movement of the first or second gear comprises an axial spline device arranged at the shaft and/or at the axially movable first and/or second gear.

7. A gear arrangement according to claim 4, wherein the means for allowing axial movement of the first or second gear comprises a helical spline device arranged on the shaft and/or on at least one of the first and second gears.

8. A gear arrangement according claim 1, wherein the control means comprises an hydraulic arrangement comprising first hydraulic means arranged to urge the axially movable first and/or second gear in a first axial direction and second hydraulic means arranged to urge the axially moveable first and/or second gear in a second axial direction being opposite to said first axial direction.

9. A gear arrangement according to claim 8, which gear arrangement comprises a plurality of load distributing devices, wherein the first hydraulic means of all load distributing devices are hydraulically connected for distributing the load of all load distributing devices at operation of the gear arrangement in a first rotational direction, and wherein the second hydraulic means of all load distributing devices are hydraulically connected for distributing the load of all load distributing devices at operation of the gear arrangement in a second rotational direction.

10. A gear arrangement according to claim 9, wherein the first hydraulic means are mutually connected by means of a first connection system enclosing a volume of a hydraulic media and the second hydraulic means are mutually connected by means of a second connection system enclosing a volume of a hydraulic media.

11. A gear arrangement according to claim 10, wherein at least one of the first and second connection systems comprises a connection center for regulating the volume and/or the hydraulic pressure in the respective connection system.

12. A gear arrangement according to claim 10, wherein the first and second connection systems share a common connection center.

13. A gear arrangement according to claim 10, wherein the first and second connection systems are hydraulically separated.

14. A gear system according to claim 1, wherein the control means comprises a resilient member such as a spring or an elastomeric member.

15. Method of distributing loads in a gear arrangement, which gear arrangement comprises an input gear or rack and output gear or rack, the method comprising the steps of;
dividing and transmitting the torque and/or motion between the input gear or rack and the output gear or rack by means of at least two transmission arrangements operationally arranged in parallel, each transmission arrangement being a load distributing device which comprises a shaft which carries a first gear meshing with the input gear or rack, and a second gear meshing with the output gear or rack, means for allowing axial movement of at least one of the first and second gears relative to the input gear or rack or to the output gear or rack respectively, and control means arranged to apply an axial force to and/or transfer an axial force from the axially movable first and/or second gear, and
transferring axial forces and/or movements of the axially movable first and/or second gear of one load distributing device to the first and/or second gear of the other load distributing devices.
